(19) United States
(12) Patent Application Publication
(10) Pub. No.: US 2019/0283535 A1
(43) Pub. Date: Sep. 19, 2019

(54) AUTOMATIC TEMPERATURE REGULATION DEVICE FOR VEHICLE PASSENGER SPACE

(71) Applicant: SHENG FU KANG INDUSTRIAL CO., LTD., TAINAN CITY (TW)

(72) Inventor: SHU-LING CHEN, TAINAN CITY (TW)

(73) Assignee: SHENG FU KANG INDUSTRIAL CO., LTD., Tainan City (TW)

(21) Appl. No.: 16/465,557

(22) PCT Filed: Jul. 20, 2017
(86) PCT No.: PCT/CN2017/093691

§ 371 Date: May 30, 2019

(51) Int. Cl. B60H 1/00; B60H 1/26; H02S 99/00

(52) U.S. Cl. CPC B60H 1/00828; B60H 1/00; B60H 1/00392; H02S 99/00; B60H 1/00657; B60H 1/00778; B60H 1/26; B60H 1/00457

(57) ABSTRACT

An automatic temperature regulation device for a vehicle passenger space. A flexible solar panel (2) is arranged on the roof (10) of a vehicle (1); solar energy is used for charging a vehicle battery (11) or a special battery (4), and an isolation cooling effect is generated; and when the vehicle is stopped for a long time, the temperature in the passenger space is detected by a temperature detection element (3) of an electric control system (14), and a vehicle air conditioning system (13) of an internal combustion engine vehicle or a pure electric vehicle is timely started by the vehicle electric control system to operate, or only the fan of the vehicle air conditioning system (13) operates, so as to regulate the temperature in the vehicle passenger space and achieve a cooling effect, thus a driver who enters the vehicle passenger space will not suffer from high temperature.

### FIELD OF THE INVENTION

This invention relates to an automatic temperature regulation device for a vehicle passenger space, particularly to an automatic temperature regulation device for a vehicle passenger space, when a vehicle is in a long-term stop state, a temperature sensing member of the electronic control system can be used to detect the temperature in the vehicle passenger space, and a vehicle air conditioning system of an internal combustion engine vehicle or a pure electric vehicle is timely started by the electric control system of the vehicle to operate, or only the fan of the vehicle air conditioning system operates, to adjust the temperature of the vehicle passenger space and achieve the effect of reducing the temperature inside the car.

### DESCRIPTION OF THE PRIOR ART

At present, various vehicle cooling devices sold in the market are provided with a cooling fan which can be directly hung on the window of the vehicle, and the power of the cooling fan is supplied by a battery or a solar power supply system. However, the foregoing vehicle cooling devices must be controlled by the driver, so it is not possible to automatically start and reduce the temperature inside the vehicle according to the state of the vehicle. Moreover, when the vehicle is exposed to the sun for a long time, the temperature of the vehicle passenger space may be as high as 84° C. or above, the inside of the vehicle is like an oven, when the driver or passenger enters the vehicle, he has to endure the high temperature, and he will feel cool after the driver starts the vehicle air conditioning system and drives a long distance.

For this reason, the inventor of this invention, having much experience in designing and manufacturing all kinds of vehicle related products, understands and researches the problem of the foregoing prior art and hence devised this invention.

### DISCLOSURE OF THE INVENTION

The purpose of this invention, is to provide a device which can directly to utilize the vehicle air conditioning system, and it is powered by vehicle battery or solar power and with heat insulation, and can directly detect the temperature of the vehicle passenger space, it can be started and cooled at any time, to allow the vehicle passenger space to maintain an appropriate temperature.

To achieve the above object, the automatic temperature regulation device for a vehicle passenger space in the present invention is provided with a flexible solar panel, the vehicle generator or solar energy can charge the vehicle battery or the special battery, and produce the effect of heat insulation and cooling, and through the temperature detecting element of the electronic control system to detect the temperature inside the vehicle passenger space when the vehicle is stopped for a long time, the vehicle air conditioning system of an internal combustion engine vehicle or a pure electric vehicle will be started timely by the vehicle electric control system to operate, or only the fan of the vehicle air conditioning system operates, so as to regulate the temperature inside the vehicle, achieve a cooling effect, the driver not to be subjected to a high temperature when entering the vehicle passenger space.

The automatic temperature regulation device for a vehicle passenger space of present invention, among which said the electronic control system is provided with a temperature detection element, to detect the temperature in the passenger space, and the vehicle air conditioning system of an internal combustion engine vehicle or a pure electric vehicle will be started timely by the vehicle electric control system to operate, or only the fan of the vehicle air conditioning system operates, to regulate the temperature inside the vehicle passenger space.

The automatic temperature regulation device for a vehicle passenger space of present invention, through the APP, the users also can operate by themselves, the vehicle air conditioning system of an internal combustion engine vehicle or a pure electric vehicle will be started by the vehicle electric control system to operate, or only the fan of the vehicle air conditioning system operates, to regulate the temperature inside the vehicle passenger space.

The automatic temperature regulation device for a vehicle passenger space of present invention, among which the electronic control system is composed of a microprocessor unit which is used to control the opening and closing of the present device, the temperature in the vehicle passenger space which is detected by the temperature detecting element can determine whether the present device is started, or through the driver's mobile phone or mobile device download the APP of present device, the operation of the present device can be operated by the user.

The automatic temperature regulation device for a vehicle passenger space of present invention, among which the solar panel charges the vehicle battery or the special battery through the charging module, and then supplies electricity to the vehicle air conditioning system through the vehicle battery or the special battery.

The automatic temperature regulation device for a vehicle passenger space of present invention, among which the special battery can be charged through the vehicle generator, and then supplies electricity to the vehicle air conditioning system.

### BRIEF DESCRIPTION OF DRAWINGS

FIG. 1 is a top view of the first embodiment in the present invention;

FIG. 2 is a side view of the first embodiment in the present invention; and

FIG. 3 is a side view of the second embodiment in the present invention.

### DESCRIPTION OF MAIN COMPONENT SYMBOLS

vehicle 1
roof 10
vehicle battery 11
vehicle passenger space 12
vehicle air conditioning system 13
vehicle electronic control system 14
flexible solar panel 2
electronic control system 3
temperature detecting element 30
special battery 4

### THE BEST WAY TO REALIZE THE INVENTION

In order for the public to be fully aware of automatic temperature regulation device for a vehicle passenger space in the present invention, according to the drawings, described as follows:

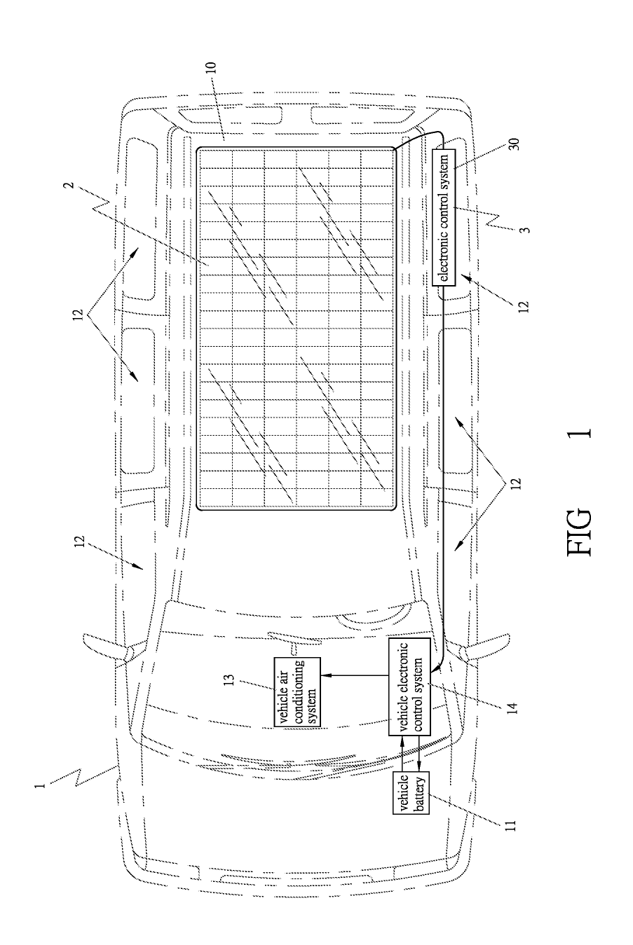

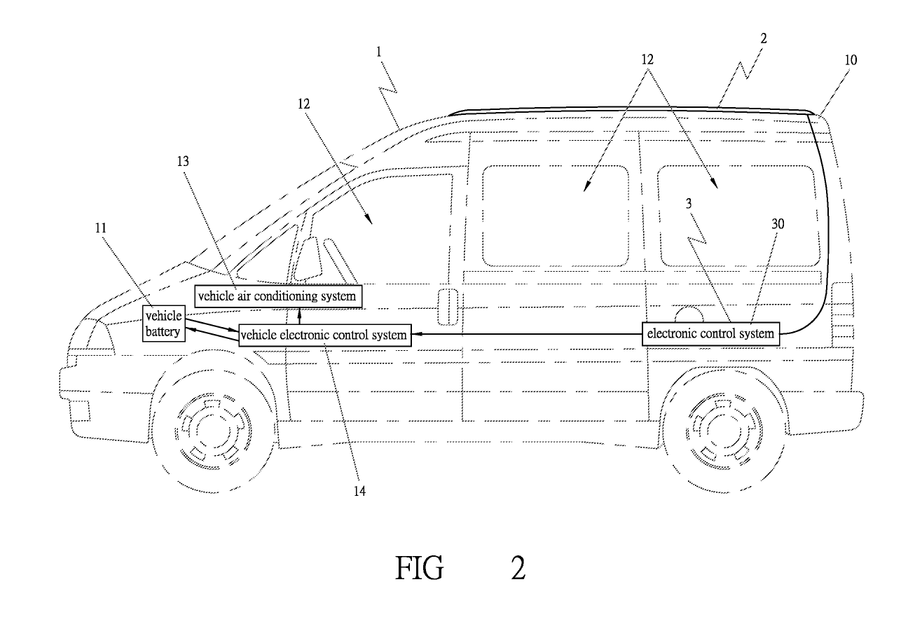

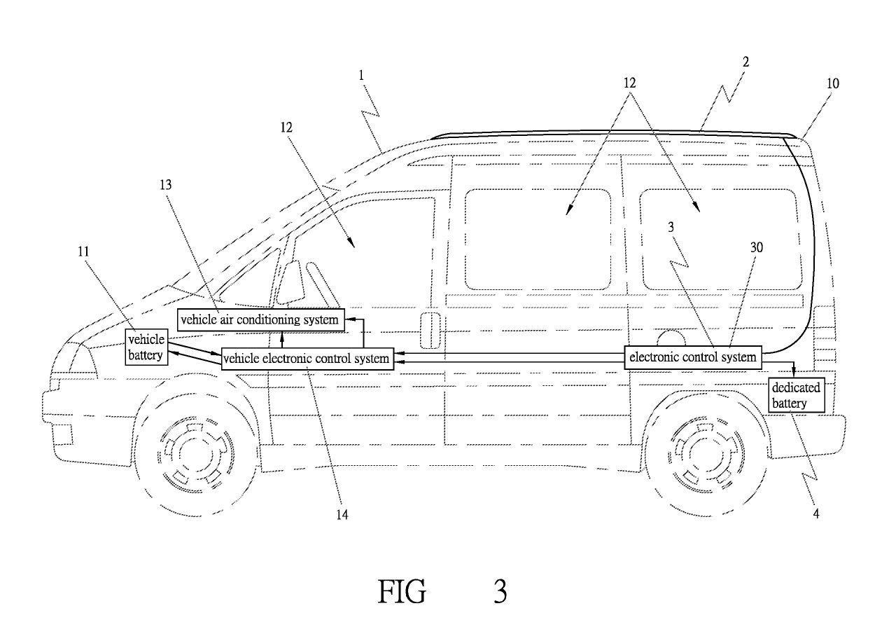

As shown in FIGS. 1 and 2, which is the first embodiment of the present invention. In the first embodiment, the roof 10 of the vehicle 1 is provided with a flexible solar panel 2, said vehicle 1 can be an internal combustion engine vehicle or a pure electric vehicle. The electronic control system 3 of the present device is provided with a charging module, said flexible solar panel 2 uses the charging module to charge the vehicle battery 11 or the special battery 4 (as shown in FIG. 3) via the vehicle electronic control system 14, and the flexible solar panel 2 color can produce an effect of heat insulation and cooling, so that the roof 10 will not directly exposed to sunlight.

Said electronic control system 3 is arranged in the proper position inside the vehicle 1, it is preferable when said electronic control system 3 is arranged inside the vehicle passenger space. Said electronic control system 3 is mainly composed of a microprocessor unit, to be the main control body of the present device. Said microprocessor unit can receive the temperature in the vehicle passenger space 12 which is detected by the temperature detecting element 30, and the microprocessor unit can determine whether the present device is started, or through the driver's mobile phone or mobile device download the APP of present device, the operation of the present device can be operated by the user. When the microprocessor unit of said electronic control system 3 receives the temperature in the vehicle passenger space which is detected by the temperature detecting element 30, after analysis, said electronic control system 3 will output a signal to the vehicle electronic control system 14 to start the vehicle air conditioning system of an internal combustion engine vehicle 1 or a pure electric vehicle 1 to operate, or only the fan of the vehicle air conditioning system operates, to automatically regulate the temperature inside the vehicle passenger space and achieve the effect of cooling.

As shown in FIG. 3, which is the second embodiment of the present invention, and the second embodiment is derived from the first embodiment. In the second embodiment, the roof 10 of the vehicle 1 is provided with a flexible solar panel 2, said vehicle 1 can be an internal combustion engine vehicle or a pure electric vehicle. The electronic control system 3 is provided with a charging module, said flexible solar panel 2 uses the charging module to charge the vehicle battery 11 or the special battery 4, or charge the vehicle battery 11 and the special battery 4 at the same time; or only charge the special battery 4 via the vehicle electronic control system 14, and the flexible solar panel 2 color can produce an effect of heat insulation and cooling, so that the roof 10 will not directly exposed to sunlight.

Said electronic control system 3 is arranged in the proper position inside the vehicle 1, it is preferable when said electronic control system 3 is arranged inside the vehicle passenger space. Said electronic control system 3 is mainly composed of a microprocessor unit, to be the main control body of the present device. Said microprocessor unit can receive the temperature in the vehicle passenger space 12 which is detected by the temperature detecting element 30, and the microprocessor unit can determine whether the present device is started, or through the driver's mobile phone or mobile device download the APP of present device, the operation of the present device can be operated by the user. When the microprocessor unit of said electronic control system 3 receives the temperature in the vehicle passenger space which is detected by the temperature detecting element 30, after analysis, said electronic control system 3 will output a signal to the vehicle electronic control system 14, and the vehicle electronic control system 14 will start the vehicle air conditioning system of an internal combustion engine vehicle 1 or a pure electric vehicle 1 to operate, or only the fan of the vehicle air conditioning system operates, to timely regulate the temperature inside the vehicle passenger space and achieve the effect of cooling.

In summary, the automatic temperature regulation device for a vehicle passenger space of the present invention through the solar panel to supply the power required by the vehicle when the vehicle is in a stopped state, and the solar panel can charge the vehicle battery or the battery of the electronic control system. Then, the electronic control system 3 can output a signal to the vehicle electronic control system 14 to determine the vehicle air conditioning system of an internal combustion engine vehicle 1 or a pure electric vehicle 1 to operate, or only the fan of the vehicle air conditioning system operates, to timely regulate the temperature inside the vehicle passenger space, when the driver and the passenger enter the car, the comfortable temperature inside the car can be felt, and the temperature difference between the inside and the outside of the vehicle will not be too large, and will not cause discomfort to the driver and passengers inside the car.

### INDUSTRIAL APPLICABILITY

The automatic temperature regulation device for a vehicle passenger space of the present invention directly utilizes the vehicle air conditioning system, and it is powered by vehicle battery or solar power and with heat insulation, and can directly detect the temperature of the vehicle passenger space, it can be started and cooled at any time, to allow the vehicle passenger space to maintain an appropriate temperature.

What is claimed is:

1. An automatic temperature regulation device for a vehicle passenger space, wherein the roof of the vehicle is provided with a flexible solar panel, the vehicle generator or solar energy can charge the vehicle battery or the special battery, and the solar panel can produce the effect of heat insulation and cooling, and through the temperature detecting element of the electronic control system to detect the temperature inside the vehicle passenger space when the vehicle is stopped for a long time, to output a signal to the vehicle electronic control system to start the vehicle air conditioning system of an internal combustion engine vehicle or a pure electric vehicle to operate, or only the fan of the vehicle air conditioning system operates, to achieve the effect of automatically regulate the temperature inside the vehicle passenger space.

2. The automatic temperature regulation device for a vehicle passenger space according to claim 1, wherein said electronic control system is provided with a charging module, said flexible solar panel uses the charging module to charge the vehicle battery or the special battery or charge the vehicle battery and the special battery at the same time.

3. The automatic temperature regulation device for a vehicle passenger space according to claim 1, wherein said flexible solar panel color can isolate the roof from the sunlight, so that the roof will not be exposed to the sun directly.

4. The automatic temperature regulation device for a vehicle passenger space according to claim 1, wherein said electronic control system is mounted inside the vehicle, and is composed of a microprocessor unit, to be the main control body of the present device, said microprocessor unit can receive the temperature in the vehicle passenger space which is detected by the temperature detecting element, and the microprocessor unit can determine whether the present device is started.

5. The automatic temperature regulation device for a vehicle passenger space according to claim 4, wherein said electronic control system allows the driver's mobile phone or mobile device to download the APP of present device, so that the operation of the present device can be operated by the user.
